(19) United States
(12) Patent Application Publication
(10) Pub. No.: US 2005/0226682 A1
(43) Pub. Date: Oct. 13, 2005

(54) Method and apparatus for improved stiffness in the linkage assembly of a flexible arm

(76) Inventors: David Chersky, Danville, CA (US); Michael Torres, Tracy, CA (US); Tamer Ibrahim, Pleasant Hill, CA (US)

Correspondence Address: GSS LAW GROUP, Suite 317, 3900 Newpark Mall Road, Newark, CA, 94560, US

(21) Appl. No.: 11/145,096

(22) Filed: Jun. 2, 2005

Related U.S. Application Data
(63) Continuation-in-part of application No. 11/069,403, filed on Feb. 28, 2005.
Application No. 11/069,403 is a continuation of application No. 10/268,397, filed on Oct. 9, 2002, now Pat. No. 6,860,668.
(60) Provisional application No. 60/327,990, filed on Oct. 9, 2001.

(51) Int. Cl. F16C 11/06

(52) U.S. Cl. 403/56

(57) ABSTRACT

A reusable articulating arm or flexible arm linkage assembly. The arm can serve as the s platform for a wide variety of instrument attachments. The flexible arm linkage assembly can be mounted to surgical table, a retractor, or self mounted. Several features of the invention include: texturing the surfaces of the links, a larger internal radius to reduce wear on the cable; a lubricious coating on the cable and/or links to reduce wear on the cable; decreasing link sized toward the distal end; an angled distal tip; a security cable; and an improved distal connector.

### CROSS-REFERENCE TO PRIORITY APPLICATION DOCUMENTS

This application is a continuation-in-part of U.S. application Ser. No. 11/069,403 filed Feb. 28, 2005, which is a continuation of 10/268,397 filed Oct. 9, 2002 now U.S. Pat. No. 6,860,668 issued Mar. 1, 2005, which claimed the benefit of provisional patent application Ser. No. 60/327,990 filed Oct. 9, 2001, the specifications and drawings of which are hereby incorporated by reference in their entirety.

### TECHNICAL FIELD

The present invention relates to articulating load bearing flexible arms, particularly suited for use as surgical tissue stabilizers, and more particularly to creating a reusable flexible arm with sufficient stiffness and durability.

### BACKGROUND ART

Flexible arms or, as they are often called, articulable columns, have many uses. For example, they are often used for positioning tools, article supports, or for locking measuring apparatus. In surgery, it is common practice to mount them as adjustable supporting brackets on a side rail of an operating table to support retractors, endoscopes and other surgical devices.

U.S. Pat. No. 4,949,927 discloses an articulable column and, more particularly, describes prior art columns of the ball and socket type which are flexible in their normal state and which, by application of tension from a central cable, become rigid.

Recent developments in heart surgery require stronger and more rigid adjustable brackets. In particular, a procedure has been introduced for carrying out cardiac bypass surgery without stopping the patient's heart. In this procedure, a device called a “tissue stabilizer” is used.

A specific prior art example, U.S. Pat. No. 5,727,569 teaches that the tissue stabilizer is attached to the wall of the heart by drawing a vacuum in an array of suction cups.

With one or more such devices attached to the wall of the heart, the site at which the repair is to take place can be held fixed while the heart continues to beat.

A tissue stabilizer is often supported using a lockable articulating column, such as disclosed in U.S. Pat. No. 5,348,259. A lockable articulating column is described as a flexible, articulable column having a central tensioning cable strung through a series of ball and socket members. Each socket member has a conical opening with internal teeth engagable with a ball made of an elastomeric polymer. When the cable is tensioned, the sockets move toward each other and the balls become indented by the teeth of the socket. The column becomes rigid when the central cable is tensioned. Releasing the tension returns the column to the flexible state.

FIG. 1 is an elevational view illustrating a tissue stabilizer supported from the side rail of an operating table by a bracket as found in the prior art of U.S. Pat. No. 5,899,425.

The assembly in FIG. 1 includes vertical post 10 attached to side-rail 12 of an operating table (not shown) by a clamp 14. The post 10 often has plural facets, which cooperate with the clamp to prevent rotation of the post relative to the clamp. A tension block 16, mounted at the top of post 10, comprises a mounting block 18 and a rotatable member 20.

In FIG. 1, one end of a flexible arm 24 is connected to the side of mounting block 18 opposite to the side having the rotatable member 20. Flexible arm 24 comprises a series of articulating elements connected to one another by ball-and-socket joints. The number of ball and socket members may be increased or decreased depending on the use of the articulating column. The flexible arm 24 has a clamp assembly 26 mounted at its other end. The clamp assembly 26 holds the shank 28 of tissue stabilizer 30.

Typically, tensioned mounting block 18 has an internal passage receiving a screw 32. Affixed to the screw is a transverse pin riding in slots formed in opposite sides of mounting block 18. The engagement of the pin with the slots prevents the screw from rotating relative to mounting block 18. The threads of the screw engage internal threads in a rotatable member 20, which also has an internal shoulder that can engage with the screw's head.

The tension cable is often a braided structure made of metal specifically built to withstand cyclical tensile fatigue. The cable may be pre-stretched to minimize further elongation of the cable caused by the application of tension. Turning the rotatable member 20 often supports cable tensions in the range of 5 to 1000 lbs.

Plastic links have a significant problem when used in a surgical theatre, they often cannot be reused due to difficulties in cleaning them. Metallic links, if feasible, would be easier to clean, reducing a costly form of surgical waste.

While there are references in the cited prior art to metal links in a flexible arm linkage assembly dating back to 1990, the inventors have only found plastic links actually in the market. The references in the cited prior art will be discussed in the next few paragraphs.

Prior art, plastic link components were found by the inventors to undergo deflections of up to a factor of 1000% for plastics such as polyethylene when tensioned. Metallic link components typically deflect by less than 50%. This difference in the materials turns out to require an entirely different approach to determining useful metallic links and their contact surfaces. The percentages used above were percent elongation derived from the reference: Materials Science and Engineering, 3rd Edition, W. Callister copyright 1985, which is hereby incorporated by reference.

U.S. Pat. No. 4,949,927 teaches in FIG. 6 and its associated discussion about a link integrating a ball and rod made of aluminum. The inventors found that this link was inoperable, due to a low coefficient of friction. By having the low coefficient of friction, such links slipped easily, far below the point of usefulness.

U.S. Pat. No. 5,899,425 teaches (FIG. 2, Col. 4, lines 7-11) “The flexible, articulating arm 24, as shown in FIG. 2, comprises a series of elements, preferably made of stainless steel. Each element has a convex, spherical surface at one end and a concave, spherical surface at the other end.”In the Summary of U.S. Pat. 5,899,425 (Column 2, lines 35-57), “The bracket is characterized by an interference fit between the spherical balls and their sockets. The diameter of each ball is preferably larger than the diameter of the socket into which it fits. The sockets are hemispherical or almost hemispherical, and their walls are sufficiently flexible to allow the balls to enter them. The very small difference in diameter, and the flexibility of the socket walls, allows the balls and sockets to be engaged over an area of contact. The terms ‘area of contact’ and ‘area contact,’ mean contact between a ball and a socket over a substantial area in a common sphere, greater than approximately 20% of the total surface area of the sphere, and is distinguishable from ‘line contact,’ which is contact between a ball and socket over a circular line or a narrow band having an area which is substantially less than 20% of the total area of the sphere corresponding to the larger of the ball or socket. The area of contact extends from the periphery of the socket to the envelope of the perimeter of the cable opening in the concave spherical surface and the circle defining the end of the convex spherical surface adjacent to the cable opening therein. The contact area is preferably approximately 30% to 40% of the total surface area of a corresponding sphere.”

The inventors found that U.S. Pat. 5,899,425 was both contradictory and inoperable in its teaching regarding metallic link components. First, maximizing the stainless steel contact area actually reduces the frictional force needed for stiffness. The disclosure from the Summary was appropriate for a plastic link component, but failed to account for the physical characteristics of stainless steel as well as alloys of iron and titanium, which do not deflect anywhere near as much as plastics.

Unlike, the prior art plastic articulating columns that are highly textured and consequently need only low tensile loads for fair rigidity, metallic link contact surfaces behave differently. This is due to the inherently lower interface friction of semi-smooth metallic mating convex and concave surfaces. Friction forces are directly proportional to these distributed contact forces. While two mating spherical surfaces would produce a large contact area, the distributed contact forces are relatively low because they are widely dispersed.

Note that a link will also be known herein as a bead.

The inventors know of no disclosure or teaching that provides for an effective metallic link for use in the linkage assembly of a flexible arm. What is needed is such an effective metallic link.

In summary, there is a need for increased stiffness in articulating joints, particularly in flexible arm linkage assemblies. There is a need for reusable links within a surgery, leading to needing metallic, reusable links. And there is a need for reusable links providing increased stiffness in flexible arm linkage assemblies.

### SUMMARY OF THE INVENTION

The present invention is directed to a reusable articulating arm or flexible arm linkage assembly. The arm can serve as the platform for a wide variety of instrument attachments that can include: coronary artery stabilizers such as compression, vacuum, or hybrid; tissue positioners and retractors, exposure instruments that retract tissue to expose other tissue or an aspect of an organ like the mitral valve; or any other instrument, like a scope holder for example.

The flexible arm linkage assembly can be mounted to surgical table, a retractor, or self mounted means such as described in U.S. application Ser. No. 10/988, 027filed Feb. 22, 2005, which is hereby incorporated by reference in its entirety.

One embodiment of the invention includes a flexible arm linkage assembly provided with a tensioning cable. The linkage assembly includes a first link with a first contact surface composed of a first contact material, and a second link with a second contact surface composed of a second, differing contact material. A high friction coupling between the first link and the second link is created by the first contact surface contacting the second contact surface when induced by the tensioning cable.

Each of the contact materials is primarily composed of a respective metallic compound, providing a higher coefficient of friction between the two contacting surfaces than would result from both contacting surfaces being composed of the same contacting material. The contacting materials are primarily composed of metallic compounds.

A flexible arm including the invention provides an increased range of motion and better stabilization of surgical instruments.

The contacting metallic compounds are further preferred to be primarily composed of alloys including at least one of iron, copper and titanium. The contacting metallic compounds are still further preferred to be at least two of the following: stainless steel, titanium, and nitinol, which will refer herein to Ni-Ti alloys.

Metallic links have a significant advantage when used in a surgery, they can be sterilized and reused many times. Using metal linkage assemblies reduces the waste products and lowers the costs associated with the use of flexible arms.

The invention includes increasing the overall metallic link to metallic link friction as a result of optimized contact geometry between the links, based upon the metallic composition of the contacting link surfaces.

Another embodiment of the invention includes optimization of metallic bead to metallic bead contact friction comprising the following steps. Maximizing the coefficient of friction between the first contact material of the first contact surface and second contact material of the second contact surface by selecting the first and second contact materials. Determining a ball diameter and conical angle to maximize frictional forces in static equilibrium based upon the coefficient of friction.

The inventors found that determining the ball diameter and conical angle maximizing static frictional forces required optimizing away from maximized contact area for a number of metals, including alloys of at least titanium, and iron, and in particular, stainless steel.

Using stainless steel for both contact surfaces, the inventors experimentally proved that they had discovered the first practical metallic link for flexible arms, providing significant improvement in the mechanical stiffness of the joint over typical plastic link components. This new metallic link used the interface geometry that resulted from their new approach to interface geometry determination.

The inventors further experimentally proved that they could make an even better joint using contact materials of stainless steel and titanium for the respective contact surfaces based upon the optimized interface geometry. The joint formed from the stainless steel contacting titanium beads had greatly improved stiffness over anything the inventors know of.

The invention includes methods of providing linkage assemblies using metallic links, as well as the linkage assembly and flexible arm as products of these methods.

The invention provides a flexible arm, also known as an articulating column, with the strength to stabilize devices holding a beating or stopped heart for an incision or the operation of a scope.

Some embodiments of the invention include features designed to improve the reusability of the device. These features include: texturing the surfaces of the links, a larger internal radius to reduce wear on the cable; a lubricious coating on the cable and/or links to reduce wear on the cable; decreasing link sized toward the distal end; an angled distal tip; a security cable; and an improved distal connector.

### BRIEF DESCRIPTION OF THE DRAWINGS

FIG. 1 is an elevational view illustrating a tissue stabilizer supported from the side rail of an operating table by a bracket as found in the prior art of U.S. Pat. No. 5,899,425.

FIG. 2 illustrates a flexible arm including a linkage assembly 1000 in accord with the invention providing increased stiffness when experimentally compared with several alternatives.

FIG. 3A illustrates a metallic linkage assembly as taught by the prior art.

FIG. 3B illustrates a metallic linkage assembly 1000 of FIG. 2.

FIG. 3C illustrates a preferred metallic linkage assembly 1000 of FIG. 2.

FIG. 4 illustrates experimental results obtained by testing a first link coupling to a second link as illustrated in FIGS. 3A to 3C, each under 200 pound tension.

FIGS. 5A and 5B illustrate two links of FIG. 3B coupling with each other through a spherical convex surface contacting a spherical concave surface.

FIG. 5C illustrates two stainless steel links of FIG. 3C coupling with each other through a spherical convex surface contacting a conical concave surface.

FIG. 5D illustrates two links of FIG. 3C coupling with each other through a spherical convex titanium surface contacting a conical concave stainless steel surface.

FIG. 6A is an exploded view of item 16 and the rotatable member 20 of FIG. 2.

FIG. 6B shows the present invention with an alternate retraction mechanism 330.

FIG. 7A shows a close-up of the ergonomically designed handle 20 of FIGS. 2 and 6A.

FIGS. 7B, 7C, and 7D, illustrate handles for other commercially available articulating columns.

FIGS. 8A and 8B show a cross section and side view of a link with a roughened surface.

FIGS. 9A and 9B show views of links with large radius of curvature for the internal cable passage.

FIGS. 10A, 10B and 10C show version of the links with detents.

FIGS. 11A, 11 B, 11C, 11D, 11E and 11F show other version of the links.

FIG. 12 is a braided security cable.

FIG. 13 shows a security cable passing through external openings.

FIG. 14 shows a flexible arm assembly having decreasing-sized links toward the distal end.

FIGS. 15A, 15B and 15C show views of the outer collar of the distal connector.

FIGS. 16A, 16B and 16C show views of the spring detent mechanism used in conjunction with the collar of Figures 15A-C.

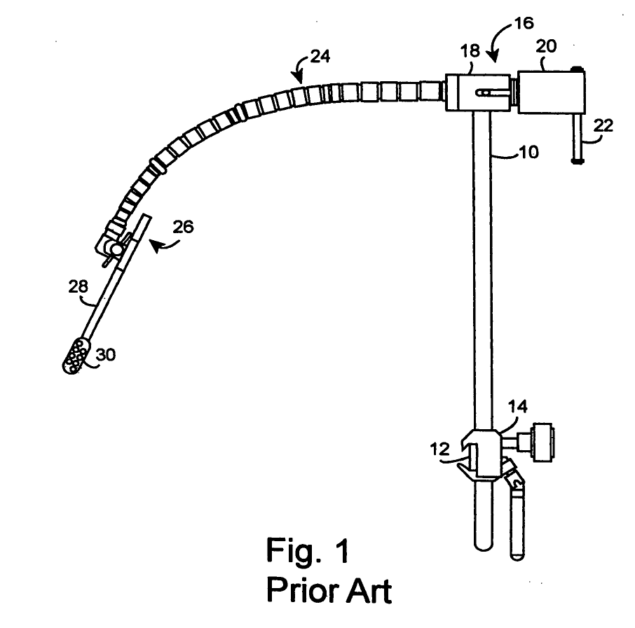

### DETAILED DESCRIPTION OF THE INVENTION

Various embodiments built in accord with the invention will be discussed. The invention increases the stiffness of flexible arm linkage assemblies, by increasing the friction between link contacts, when in a locked configuration operating similarly to existing plastic based linkage assemblies.

The invention includes a flexible arm linkage assembly provided with a tensioning cable. The linkage assembly includes a first link with a first contact surface composed of a first contact material, and a second link with a second contact surface composed of a second, differing contact material. A high friction coupling between the first link and the second link is created by the first contact surface contacting the second contact surface when induced by the tensioning cable.

Each of the contact materials is primarily composed of a respective metallic compound, or compounds, providing a higher coefficient of friction between the two contacting surfaces than would result from both contacting surfaces being composed of the same contacting material.

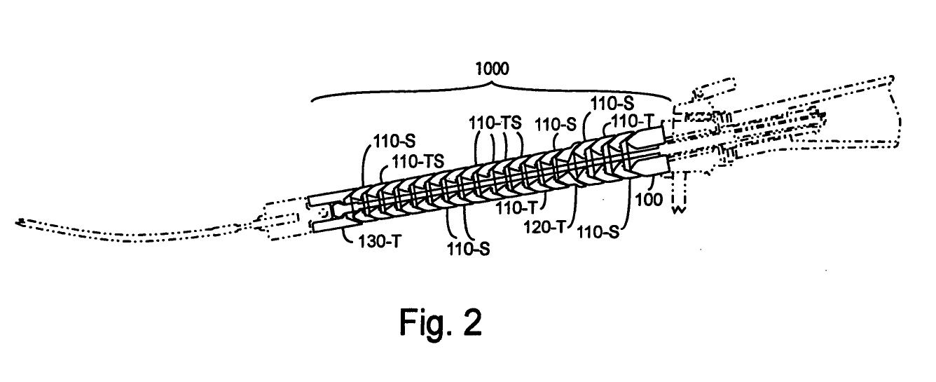

FIG. 2 illustrates a flexible arm including a linkage assembly 1000 in accord with the invention providing increased stiffness when experimentally compared with several alternatives.

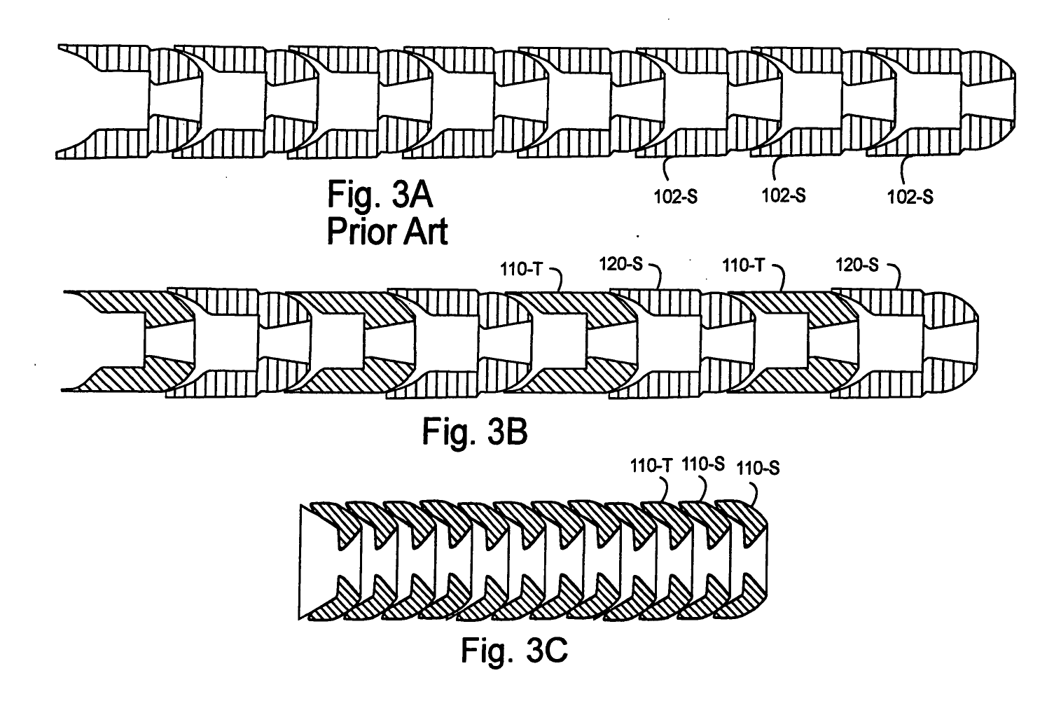

FIG. 3A illustrates a metallic linkage assembly as taught by the prior art.

FIG. 3B illustrates a metallic linkage assembly 1000 of FIG. 2.

FIG. 3C illustrates a preferred metallic linkage assembly 1000 of FIG. 2.

In FIG. 2, linkage assembly 1000 includes a link 130-T coupling with link 110-S and link 100 coupling with link 110-S. As used herein a link 110-S will refer to a link shape 110 composed primarily of stainless steel. A link 110-T will refer to a link shape 110 composed primarily of titanium.

A link may employ two or more distinct metallic compounds, typically one for each contact surface. Note that it is also within the scope of the invention to use separate materials within a link for the contact surfaces, as well as for the body joining the two contact surfaces.

A link 110-TS refers to a link possessing a concave surface primarily composed of a titanium alloy, and a convex surface primarily composed of a stainless steel alloy. Note that a link 110-ST refers to a link possessing a concave surface primarily composed of a stainless steel alloy, and a convex surface primarily composed of a titanium alloy. The concave and convex surfaces both support a tensioning cable traversing through their link.

The concave and convex surfaces preferably embody shapes, which for their materials, maximize static friction as well as kinetic friction when contacting each other under tension.

In FIGS. 2, 3B, and 3C, there are four linkage shapes used, 100, 110, 120 and 130.

Each linkage shape includes at least one contact surface, which contact couples to a neighboring contact surface of another link. Links 100 and 130 each have exactly one contact surface, which are convex and concave, respectively. Links 110 and 120 each have two contact surfaces, one concave and the other convex.

The invention includes linkage assemblies provided with a tensioning cable and including the following. A first link forming a first contact surface composed of a first contact material. A second link forming a second contact surface composed of a second contact material. The tensioning cable traversing through the first link and the second link.

In certain embodiments, a high friction coupling between the first link and the second link is created by the first contact surface contacting the second contact surface when induced by the tensioning cable. The first contact material is distinct from the second contact material. Each of the contact materials is primarily composed of a respective metallic compound. The first contact surface, composed of the first contact material, contacting the second contact surface, composed of the second contact material, has a higher friction coefficient than results from composing both contact surfaces of either contact materials. This higher friction coefficient is preferably greater than 0.3.

Preferably, each of the respective metallic compounds is primarily composed of at least one alloy containing at least one member of the collection comprising: iron, copper, and titanium. However, other materials including other metals and alloys may be useable.

Further preferred, each of the respective metallic compounds is primarily composed of an alloy belonging to the collection comprising: stainless steel, titanium, and nitinol.

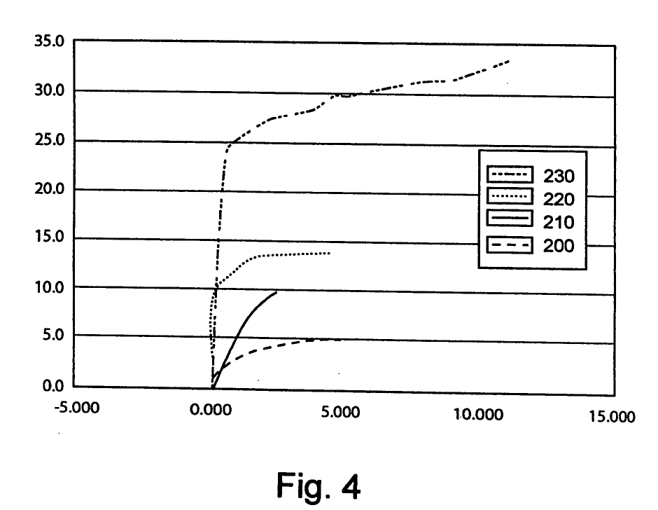

FIG. 4 illustrates experimental results obtained by testing a first link coupling to a second link as illustrated in FIGS. 3A to 3C, each under 200 pound tension.

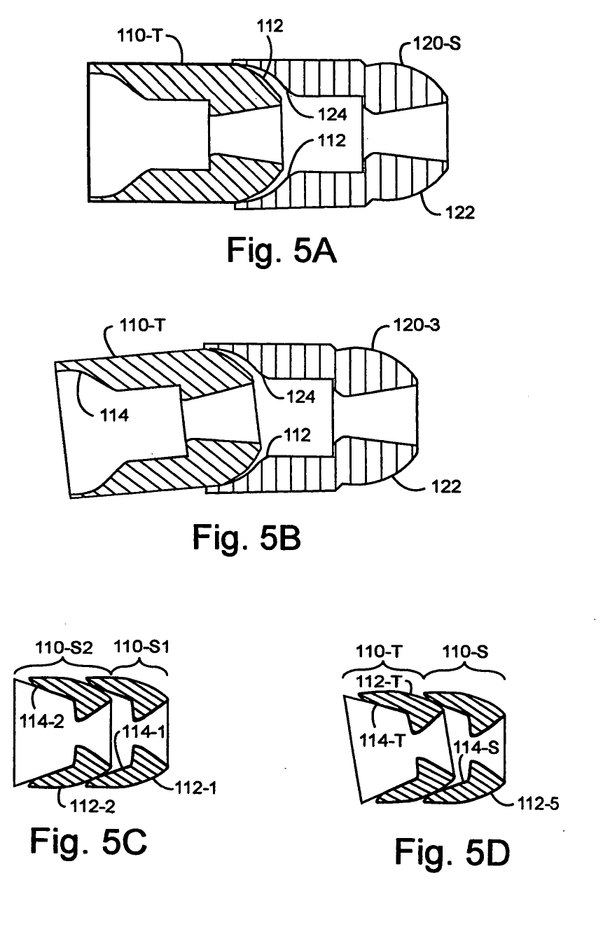

FIGS. 5A and 5B illustrate two links of FIG. 3B coupling with each other through a spherical convex surface contacting a spherical concave surface.

In FIGS. 5A and 5B, the spherical convex surface 112 connects with the semi-spherical concave surface 124. The diameters of the two surfaces are preferably slightly different, with the convex semi-spherical 112 diameter being larger than the semi-spherical diameter of the interfacing concave surface 124. Convex surface 112 and concave surface 124 form an interference fit when the two surfaces contact each other under tension. The wall of link 120-S is sufficiently thin and resilient where the two surfaces come together to provide an area contact between the first link and the second link.

FIG. 5C illustrates two stainless steel links of FIG. 3C coupling with each other through a spherical convex surface contacting a conical concave surface.

FIG. 5D illustrates two links of FIG. 3C coupling with each other through a spherical convex titanium surface contacting a conical concave stainless steel surface.

In FIG. 5C, the spherical convex surface 112-2 connects with the conical concave surface 114-1. The diameters of the two surfaces are preferably slightly different, with the convex semi-spherical 112-2 diameter being larger than the conical diameter of the interfacing concave surface 114-1. Convex surface 112-2 and concave surface 114-1 form an interference fit when the two surfaces contact each other under tension. The wall of link 110-S1 is sufficiently thin and resilient where the two surfaces come together to provide an area of contact with each other.

Percentages referenced in this paragraph were percent elongation. Taken from Reference: Materials Science and Engineering, 3rd Edition, W. Callister copyright 1985.

In FIG. 5D, the spherical convex surface 112-T connects with the conical concave surface 114-S. The diameters of the two surfaces are preferably slightly different, with the convex semi-spherical 112-T diameter being larger than the conical diameter of the interfacing concave surface 114-S. Convex surface 112-T and concave surface 114-S form an interference fit when the two surfaces contact each other under tension. The wall of link 110-S1 is sufficiently thin and resilient where the two surfaces come together to provide an of area contact with each other.

In FIGS. 5A to 5D, the circular edge of the opening of each link is preferably concentric with the center of the imaginary sphere in which the surface lies when the links are fully engaged with each other. The edge is rounded to avoid a sharp edge that could damage the tensioning cable. The rounded edge has a very small radius of curvature to maximize the contact area of the mating convex and concave surfaces. The fact that the edge is rounded instead of sharp has negligible effect on the contact area.

The diameters of the convex and mating concave link surfaces may preferably vary over the length of the linkage assembly. This supports the need for increased strength and/or stiffness at the proximal end of the articulating arm near tension block 18, where the applied mechanical moment is greatest. The applied moment is greatest at the proximal end of the flexible arm because the moment arm to the point of loading is greatest. Often, the flexible arm is oriented at the proximal end in a way that amplifies this effect.

The joints at the proximal end of the arm are preferably larger in diameter. This increases their rotational inertia, or resistance to rotation, in addition to providing greater frictional contact area than smaller distal beads located furthest from tension block 18.

The greatest load-bearing link is usually the most proximal link. This link is sunk into the body of the articulating column providing a mechanical lock, prohibiting rotation of this link.

Distal links which need not provide such a great magnitude of resistance to angular displacement, due to the smaller applied moment, are preferably smaller in diameter to facilitate a lighter, less obtrusive design. This is useful in a surgery, where any protruding object may catch on fabric, tape, etc., distracting the surgical personnel.

Links preferably do not deform more than 0.01% from their relaxed circumference when fully loaded. This small deformation is achieved specifically because of the use of metal materials of the joint elements. A plastic bead would have to be impracticably thick to achieve this constraint.

Generally, the interference fit of the balls and sockets of the link, and more importantly, the significant area of contact between them, together provide the rigidity necessary for tissue stabilization in heart surgery. These features also allow the bracket to be adjusted easily and locked into its rigid condition by the application of a moderate force on the cable.

However, the rigidity of the arm can be substantially improved by improving the friction coefficient between links by differing selected materials between the links. This can be accomplished by fabricating adjacent articulating elements of differing materials, or by using coatings or other modifications to the contacting surfaces.

In the experimental data provided in FIG. 4, the links of FIGS. 3A to 3C, each used essentially one metallic compound.

In FIG. 4, the bottom curve 200 shows the performance of an existing link.

In FIG. 4, the second curve 210 is the performance of first link interface from a competitive device made of plastic.

In FIG. 4, the third curve 220 shows the performance of an improved high friction coupling of metallic contact surfaces in accord with certain aspects of the invention. The tensioning cable induces contact between the first contact surface and the second contact surface providing a maximal static friction combined with a maximal kinetic friction between the first link and the second link through a contact region.

The experimental data present by curve 220, uses a contact region is smaller than a maximal contact region obtained from altering at least one member of the collection comprising the first contact surface and the second contact surface. Such alterations include relatively small changes in the shapes and relative sizes of one or both contact surfaces.

In FIG. 4, the top curve 230 shows the performance of the preferred high friction coupling. The tensioning cable induces contact between the first contact surface and the second contact surface providing a maximal static friction combined with a maximal kinetic friction between the first link and the second link through a contact region as found in curve 220. Additionally, the contact materials are stainless steel and titanium.

The applied moment can be thought of as the amount of torque that the arm can resist before undergoing angular displacement.

The important point on these curves is where a device begins to deviate from vertical, not where it plateaus. For instance, curve 200 for Device 1 begins to move around 2 in-lbs, whereas the Ti-SS links with the preferred contact surfaces begin to move up around 25 in-lbs.

The inventors analyzed the forces on the contact surfaces of a pair of coupling links. This led to an insight regarding the parameters governing the static equilibrium conditions. The static equilibrium equations were solved for the maximum moment that could be supported prior to slippage at the interface. The inventors found the influence of the friction was very nonlinear.

The friction coefficient of the contacting metallic surface is preferably greater than 0.3. The friction coefficient of the contacting metallic surface is further preferred greater than 0.35. The friction coefficient of the contacting metallic surface is further preferred greater than 0.375. The friction coefficient of the contacting metallic surface is further preferred greater than 0.3875. An analysis performed by the inventors indicates that a flexible arm with a friction coefficient of 0.4 would be twice as stiff as one with a friction coefficient of 0.3.

The flexibility of an articulating column using the invention allows for an attached retractor to reach all portions of an organ, such as the heart. This is because of the small bend radius that has been made possible by the invention. The flexibility afforded by the small bend radius is possible because of the geometry and rigidity of the joints keeping the same stabilization of the organ as prior art device requiring greater bend radii.

The flexibility of an articulating column using this invention is increased over existing designs due to the conical angle at the convex and concave surfaces of the respective links.

Proximal links have a larger conical angle, afforded by their larger overall size. This increases the range of motion of the column by increasing the range of motion of the proximal links near to tension block 18.

Smaller distal links have smaller conical angles, but also smaller distance from the articulating surface to the center of rotation, creating a uniform range of motion throughout the device.

For all links, the tension cable traverses freely through the links when the links are rotated to the extent of their articulating surfaces. This supports the range of motion being limited by the link design rather than the cable.

The rigidity of the articulating column can be attributed to increased friction resulting from a combination of geometric and materials factors.

The geometry of the two metallic contacting surfaces preferably acts to amplify the contact forces that are produced by applying tension to the tensioning cable.

In the case of certain embodiments of the invention, the spherical convex surface of one link preferably mates with a conical concave surface of another link. This mismatch produces larger contact forces distributed over a smaller relative area. With metals, the magnitude of these contact forces must exceed a threshold for static frictional forces to meet conditions of static equilibrium under a given applied moment. The radius of curvature of the convex surface is preferably large enough such to provide an adequate amount of contact area, further increasing the frictional forces.

A transition link that joins two links of different diameter may have spherical surfaces on both the convex and concave contact surfaces to facilitate the transition within the confined space. These geometric factors compliment the material selection, designed to increase the coefficient of friction between links.

Certain preferred flexible arms are fixed to the body of the clamp 18, and the terminal element, or in some embodiments several terminal elements, may be fixed to a surgical device. In alternate embodiments all joints may be flexible.

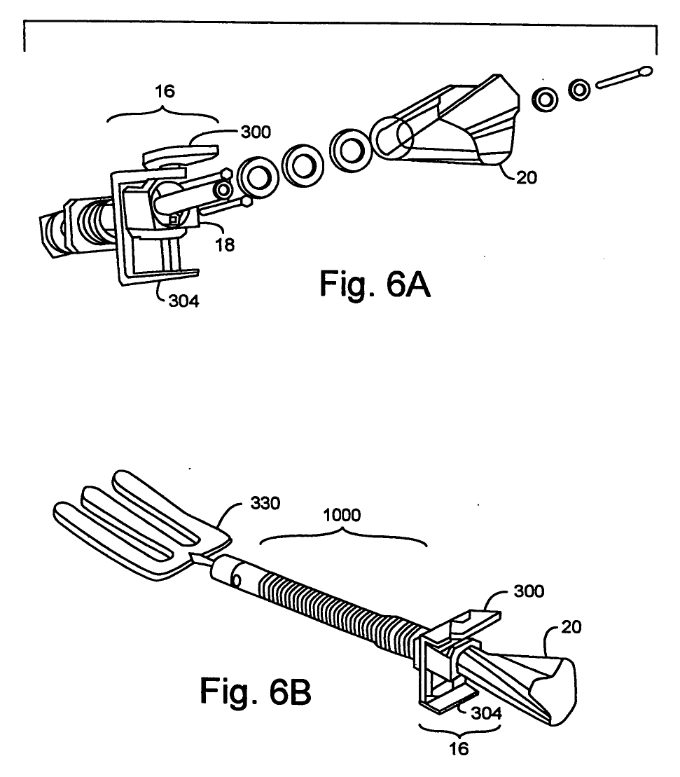

FIG. 6A is an exploded view of item 16 and the rotatable member 20 of FIG. 2.

In FIG. 6A, the mechanism that supports the articulating column attaches to the supporting structure using a “C” bracket 304 and a tension block 18 applies tension to the supporting structure. This connection mechanism is both secure and is capable of a rapid disconnect.

In FIG. 6A, the tension block 16 is forced down by a screw mechanism that is driven by turning handle 300. The advantage of this pivoted handle is that the screw mechanism does not extend further than 3 mm past the upper surface of the clamp for a profile suitable for less invasive surgery.

FIG. 6B shows the present invention with an alternate retraction mechanism 330.

This and other attachments to an articulating column are possible and those skilled in the art can make suitable modifications for attachment of at least a variety of medical tools. The usefulness of the invention is not limited in scope to medical applications. The scope of the invention is intended to cover any linkage assembly of a flexible arm needing improved rigidity.

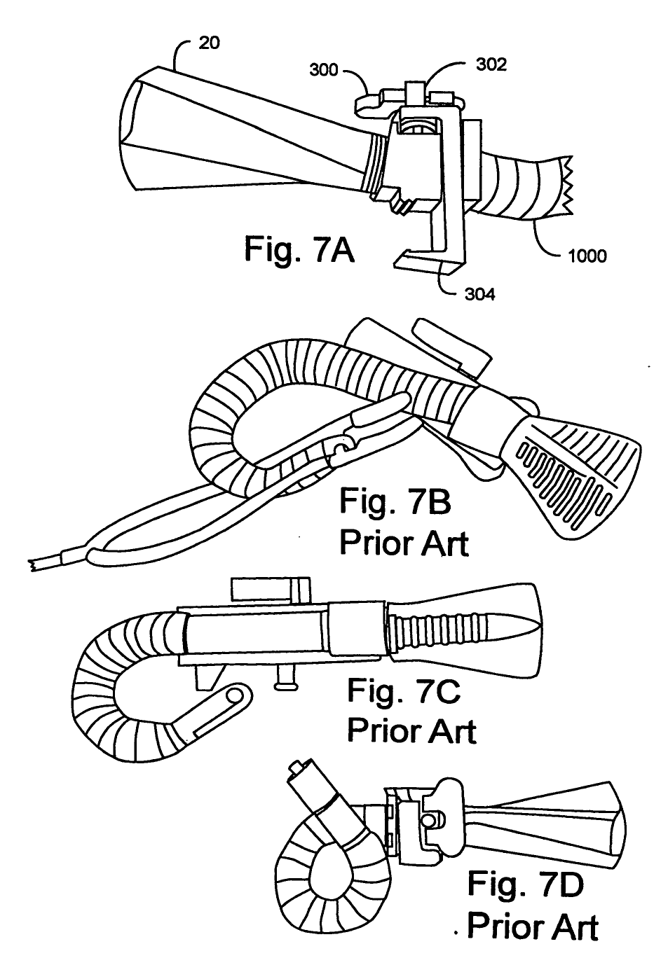

FIG. 7A shows a close-up of the ergonomically designed handle 20 of FIGS. 2 and 6A.

In FIG. 7A, handle 20 has a helical angle suited for right-handed people to oppose the thumb when tightening the handle. Also shown is a better view of clamp apparatus 16. Tension block 18 is driven towards “C” bracket 304 by screw 302 when turning pivot handle 300. This exemplary embodiment is not the only attachment means to support an articulating column including the invention's linkage assembly 1000. Those skilled in the art will appreciate that other attachments are possible and may be considered as alternate embodiments of the present invention.

FIGS. 7B, 7C, and 7D, illustrate handles for other commercially available articulating columns.

The present invention allows an articulating column with a greater range of motion or smaller flexible radius of curvature. This can be attributed to the conical angles used in the convex surfaces of each articulating bead, through which the tension cable passes.

In FIG. 7A, the proximal 4 beads have a conical angle of 40 degrees where as the remaining distal beads have a conical angle of 25 degrees. The larger conical angle allows for increased flexibility because the cable has more space to bend.

Following are several embodiments of the invention that have been specifically designed to be reusable without losing functionality. In order to provide a reusable device a material is used that is durable, biocompatible, and that can be re-sterilized using commonly using hospital steam sterilization. One option for the links is metallic alloys. The metallic alloys provide superior rigidity to competitive devices that are manufactured with polymeric materials.

With the use of the metallic alloys, the surgeon now has a reusable base platform and need only purchase disposable attachments. For some devices, the attachments are reusable as well. The same platform can be used for a wide variety of attachments for many different applications. A universal clamp to service a wide variety of mounting options, based on a simple vise clamp, may be used.

In designing a reusable arm, one important factor is minimizing repeat wear to the components, thereby increasing the usable life. An arm with limited shelf life or one that fails during use would not be attractive to a surgical team.

One common mode of failure of a reusable articulating arm is internal cable failure. As the cable is shortened, it creates the compressive forces between adjacent links to rigidify the arm. As this occurs tensile fatigue forces are repeatedly applied to the cable. Furthermore, shear forces are applied to the strands in contact with the inner radius of the links. If these radii are small they contact a finite area of the cable and act as a knife edge, greatly wearing a localized area of the cable as it slides over these edges. If the arm is forcefully moved when in the rigid state (when all the slack is already removed from the cable), large loads will stretch the cable strands and greatly accelerate failure. Finally, the lower the coefficient of friction is between the adjacent links the greater the required cable tension to increase frictional forces between links. Several features of the present invention may be combined to help minimize the cable load.

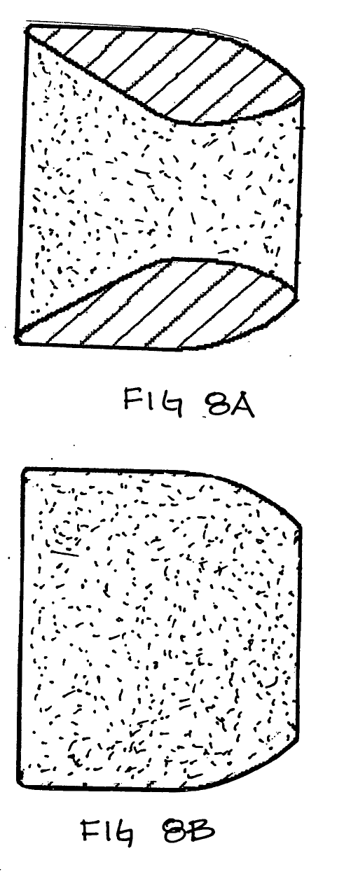

First, the surface of the links may be textured as seen in FIGS. 8A and 8B. Texturing the concave and convex surfaces of the links increases the link to link friction thereby minimizing the required tension force and minimize load to cable. The texturing can be achieved by dimpling, bead blasting, EDM or otherwise texturing both concave and convex surfaces of adjacent links to increase surface roughness.

Another feature that may be used to decrease is increasing the radius of curvature of areas contacting tension cable. FIGS. 9A and 9B show version of the links.

Tension cables are typically given a failure load rating based on a specific pulley diameter or bend radius. A smaller curvature provides the surgeon with maximum flexibility. However, in this severely bent configuration the strength and life of the cable is decreased as the cable has fewer strands taking more of the load along the inside of the bend radius. The same strands are also contacting the potentially sharp edges of the inside diameters of the links. In order to create the specific configuration of the link, a bend radius is selected as the minimum radius of curvature permissible for the cable. Then, the shape of the adjacent links is designed to provide a gentle contour creating the selected radius, thereby more evenly distributing the load to more of the cable strands and minimizing contact forces applied to the contacting strands.

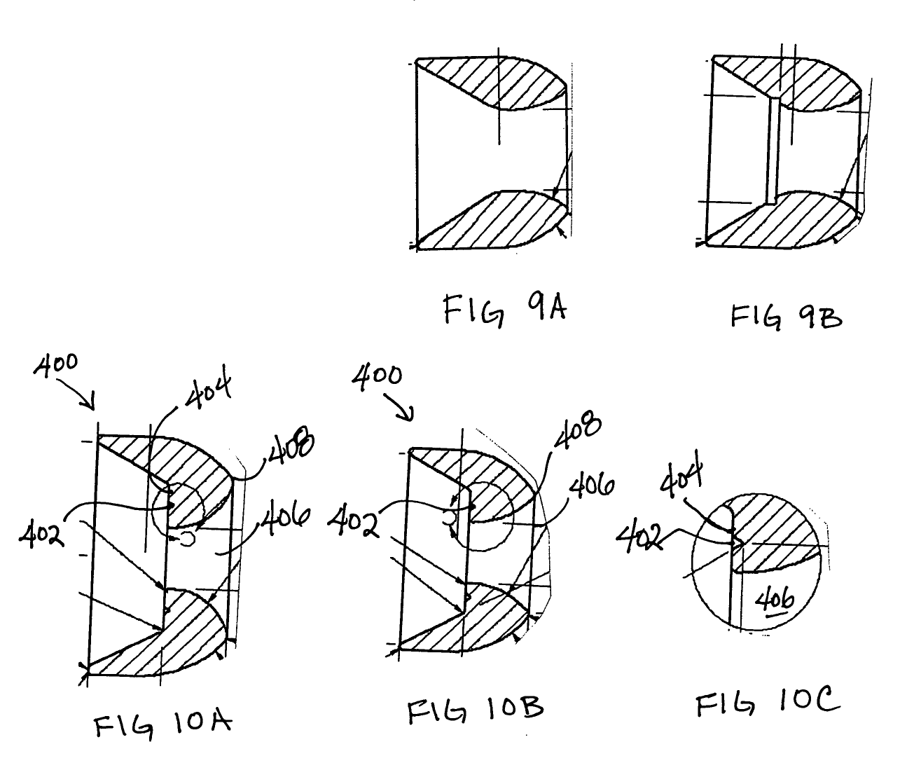

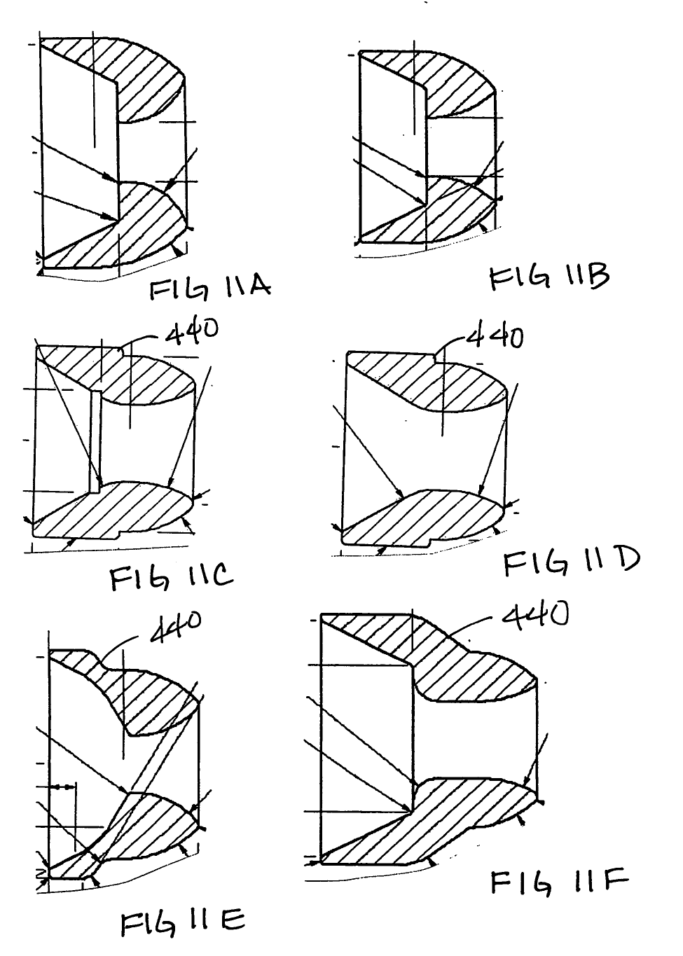

FIGS. 10A, 10B and 10C show variations of the link 400 that have a detent 402 in the end surface 404 of the internal cable passage 406. When the tension cable is tighten within the cable passage 406, and the links 400 are a pre-selected curvature, the tip 408 of one link is held in place in the detent 402 of the adjacent link. The location of the detent 402 determines the pre-selected curvature.

FIGS. 11A, 11B, 11C, 11D, 11E and 11F show other version of the links having other curvatures and other possible features that may be added to any of the embodiments of the links. For example, FIGS. 11C and 11D show and external ridge 440 that prevents the arm assembly from bending beyond a preset limit. In Figures 11E and 11F, the ridge is more tapered to provide a smoother external profile of the arm assembly.

Decreasing the coefficient of friction between cable and contact surfaces also improves the life of the cable. A thin, biocompatible material may be used to provide a hard and lubricious surface. With no surface treatment, the cable may catch on the internal surface of the links causing large contact forces and strains on portions of the cable. The lubricious surface allows the cable to more easily slide along the surfaces of the links as tension is applied, thereby reducing the chance of larger point load or frictional wear on the cable. One option for the lubricious surface is hard chrome plating. The chrome is hard and lubricious, and thus serves as a good material for plating if the desired result is wear resistance. The links, the cable or both may be coated to provide this advantage. If the surface texturing is used on the links, the most cost effective solution is to coat the cable with the lubricious material.

If the cable fails in an arm with a single uniform cable, when the cable fails, nothing is left holding the links together. This allows the links to fall into the surgical field. Therefore, examination of the cable prior to use is important. However, cable failure is inevitable with repeated use, a security cable may be added. The security cable may take several forms. In one embodiment, the security cable is one or more strands of an elastic or superelastic material 474 such as a nickel titanium alloy is wound into the tension cable 470. When the rest of the strands 472 of the cable 470 fail, the elastic nature of the elastic strand 474 will cause that portion of the security cable 470 to stretch and allow the flexible arm to fail while still holding the links together. One particular configuration, shown in FIG. 12 of this type, a 7×7 cable which is 7 braided strands each with 7 wires, the center strand 474 is being Nitinol and remaining strands 472 are stainless steel. As the Nitinol strand stretches 474, the surgeon will continue to tighten the handle trying to rigidify the arm and be alerted to the failure by the fact that the arm does not rigidify with only one elastic strand 474 intact.

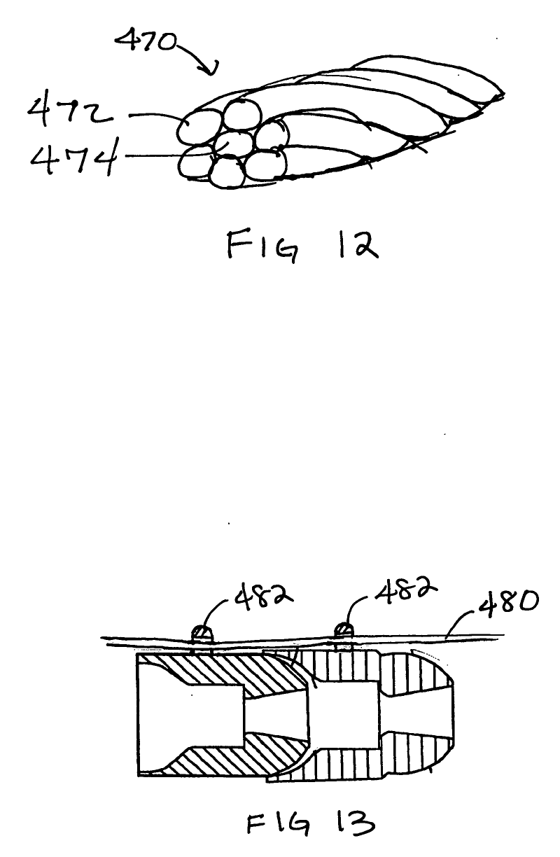

Alternately, a longer and/or elastic secondary cable may be used as the security cable. The secondary cable may extend through the same central passage as the tensioning cable. In another embodiment, the secondary cable 480 may be located external to the central passage, as seen in FIG. 13. If the cable is external, the links will be connected to the cable by any suitable means, including a side opening 482 through which the secondary cable passes or the links may be permanently attached to the cable by welding, adhesive or other mechanical means.

Devices using polymeric links may benefit from the addition of some of these features, such as the security cable and texturing of the links to increase rigidity.

Minimal bulk is desired at the distal end of the flexible arm assembly, adjacent to the attachment and surgical site. One embodiment of the flexible arm assembly has links of decreasing size towards the distal end of the arm assembly. With the variation in the size of the link, the flexible arm provides the surgeon with both minimal size at the distal end and superior strength by increasing the link diameter towards the proximal end of the arm. The moment arm of the device and therefore the force to be resisted is greatest at the proximal end. The increased link size near the proximal end provides the necessary resistance to withstand the increased forces at this location. At the distal end the moment arm is very small and therefore the smaller links provide sufficient resistance to the forces applied. An example of this embodiment is shown in FIG. 14. In the example show only two links of each size are shown. However, a single link of each size or a greater number of each size link may be used depending on the forces to be applied and the overall desired length of the arm assembly.

In order to function, the arm assembly must meet minimum length requirements (i.e. it must reach from wherever it is mounted to the surgical site and allow the surgical procedures to take place. However, the actual length of the device may be reduced by optimizing the entry angle of the arm. This may be accomplished by angling the most distal link of the arm. The angled approach decreases the required length of the arm and also minimizes the height of the device, thereby improving the ergonomics for the surgeon.

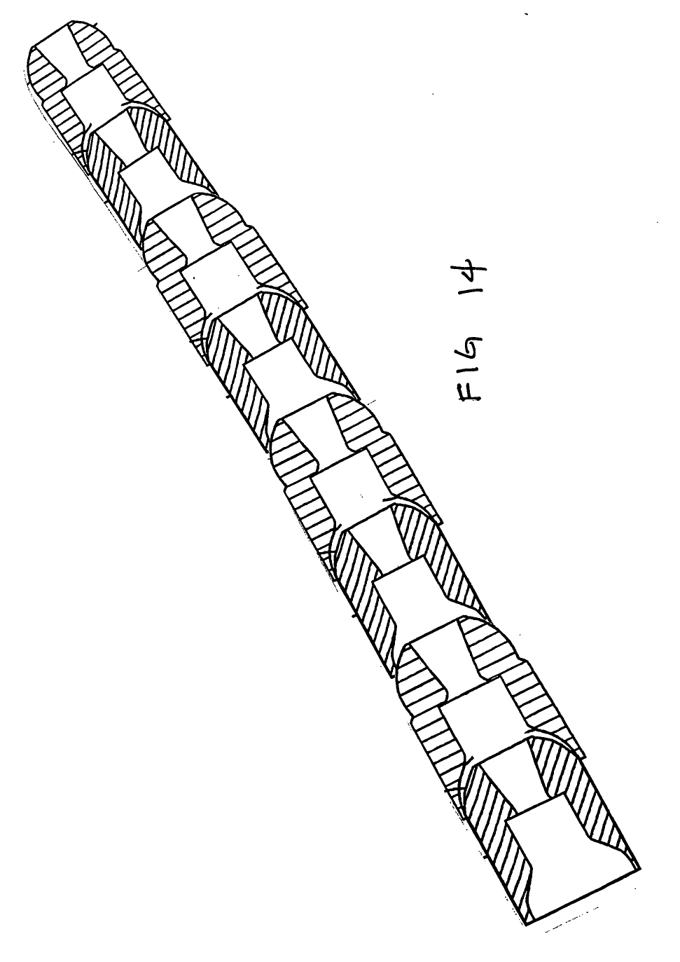

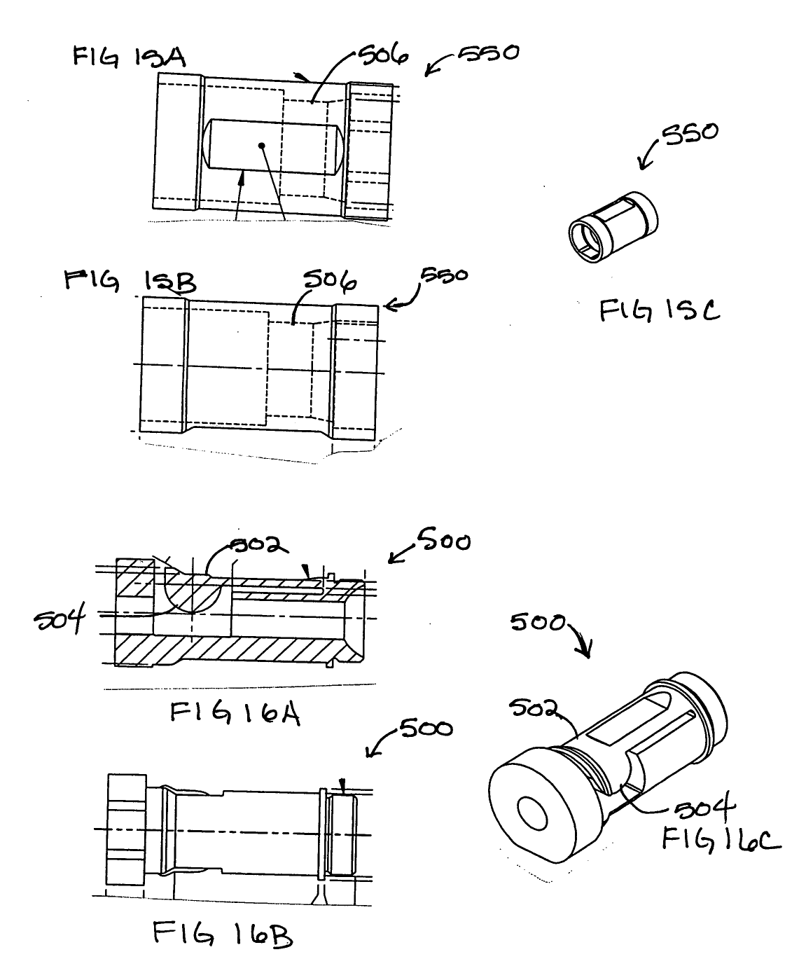

A distal connector is show in FIGS. 15 and 16. FIGS. 15A, 15B and 15C are the outer collar and FIGS. 16A, 16B and 16C are the inner cylinder. Optimally, the attachment is easy to use, durable and can meet the desired size constraints of the distal end of the arm. It is desired that the diameter of the distal feature be minimized to eliminate bulk in the surgical field. It is also desirable that the rigid distal element be minimized in length to improve flexibility of the arm.

The problem with the prior art lies in the inability to reduce its size to the ball bearing configuration. The present invention overcomes this problem by utilizing a spring loaded sliding mechanism where the inner cylinder 500 is designed with a deflectable portion 502 that creates a spring effect. The inner surface of the deflectable region is designed with a spherical surface 504 to mate with the shaft track detent. The collar 550 is design to include a necked down portion 506 such that the inner diameter coming into contact with the deflectable portion 502 of the cylindrical component 500 is smaller where the spring is relaxed and larger where the spring is loaded. Therefore, to insert the shaft the deflectable portion 502 is loaded and the collar 550 does not contact or apply forces to the inner deflectable component 502, therefore the shaft can be inserted, once again only in the configuration where the spherical convex region 504 of the deflectable portion 502 mates with the spherical concave region of the shaft detent. When the collar 550 is released, the spring forces of the deflectable portion 502 return the collar 550 to its relaxed position where the collar 550 internal diameter is smaller when it comes into contact with the deflectable portion 502 of the connector 500, 550, forcing the deflectable spherical ball 504 to seat in the recessed spherical ball groove of the shaft, locking its axial and rotational position. This configuration utilizes the elastic properties of the cylindrical material to create a quick connect. Further, integrating the deflectable spherical component 504 eliminates the need for a ball bearing, significantly reducing the size of the quick-connect component. Although other material may be used, the current embodiment uses stainless steel.

Although exemplary embodiments of the invention have been described in detail above, many additional modifications are possible without departing materially from the novel teachings and advantages of the invention.

For example, different dissimilar metals may be considered for different friction coefficients, different contact surfaces achieving similar static equilibrium requirements, to create the flexible arm linkage assemblies. The flexible arms may use different support attachment mechanisms and different retractors for connection to the articulating column.

1. A flexible, articulated arm comprising:
a first link having a first contact surface, a second contact surface and a first cable opening passing therethrough,
a second link having a third contact surface, a fourth contact surface and a second cable opening passing therethrough,
a third link having a fifth contact surface, a sixth contact surface and a third cable opening passing therethrough,
wherein each of the first, second, third, fourth, fifth and sixth contact surfaces are textured,
wherein said second contact surface engages said third contact surface and wherein the texturing on said second and third contact surfaces increases a first frictional forces,
wherein said fourth contact surface engages said fifth contact surface and wherein the texturing on said fourth and fifth contact surfaces increases a second frictional forces,
and a tension cable extending through said first, second and third cable openings.

2. The flexible, articulated arm of claim 1, wherein the texture on all of the contact surfaces is created by dimpling.

3. The flexible, articulated arm of claim 1, wherein the texture on all of said contact surfaces is created by bead blasting.

4. The flexible, articulated arm of claim 1, wherein the texture on all of said contact surfaces is created by electrical discharge machining.

5. The flexible, articulated arm of claim 1, wherein the texture on all of said contact surfaces is created by metal injection molding.

6. The flexible, articulated arm of claim 1, wherein the first and second coefficients of friction are at least 0.3.

7. The flexible, articulated arm of claim 1, wherein the first and second coefficients of friction are at least 0.35.

8. The flexible, articulated arm of claim 1, wherein the first and second coefficients of friction are at least 0.375.

9. The flexible, articulated arm of claim 1, wherein the first and second coefficients of friction are at least 0.3875.

10. A flexible, articulated arm comprising:
a first link having a first contact surface, a second contact surface and a first cable opening passing therethrough,
a second link having a third contact surface, a fourth contact surface and a second cable opening passing therethrough,
a third link having a fifth contact surface, a sixth contact surface and a third cable opening passing therethrough,
wherein said second contact surface engages said third contact surface,
wherein said fourth contact surface engages said fifth contact surface,
and a tension cable extending through said first, second and third cable openings
wherein a portion of a sidewall of each of said first, second and third cable openings have a radius of curvature of at least 0.05 inches, thereby decreasing contact force on said tension cable by each of the links.

11. The flexible, articulated arm of claim 10, wherein said radius of curvature is at least 0.10inches.

12. The flexible, articulated arm of claim 10, wherein said radius of curvature is at least 0.15 inches.

13. The flexible, articulated arm of claim 10, wherein said radius of curvature is at least 0.20 inches.

14. The flexible, articulated arm of claim 10, wherein said radius of curvature is at least 0.25 inches.

15. A flexible, articulated arm comprising:
a first link having a first contact surface, a second contact surface and a first cable opening passing therethrough,
a second link having a third contact surface, a fourth contact surface and a second cable opening passing therethrough,
a third link having a fifth contact surface, a sixth contact surface and a third cable opening passing therethrough,
wherein said second contact surface engages said third contact surface,
wherein said fourth contact surface engages said fifth contact surface,
and a tension cable extending through said first, second and third cable openings,
wherein at least one of said tension cable and said first, second and third links are coated with a lubricious material.

16. The flexible, articulated arm of claim 15, wherein the lubricious material is chrome.

17. The flexible, articulated arm of claim 15, wherein the lubricious material is formed by plating chrome onto said tension cable.

18. The flexible, articulated arm of claim 15, wherein the tension cable is coated with chrome.

19. A flexible, articulated arm comprising:
a first link having a first contact surface, a second contact surface and a first cable opening passing therethrough,
a second link having a third contact surface, a fourth contact surface and a second cable opening passing therethrough,
a third link having a fifth contact surface, a sixth contact surface and a third cable opening passing therethrough,
wherein said second contact surface engages said third contact surface,
wherein said fourth contact surface engages said fifth contact surface,
and a tension cable formed from a plurality of strands and extending through said first, second and third cable openings, wherein said tension cable includes at least one strand of an elastic material.

20. The flexible, articulated arm of claim 19, wherein said tension cable is formed of a plurality of stainless steel strands and said at least one strand of elastic material.

21. The flexible, articulated arm of claim 19, wherein said elastic material is a superelastic material.

22. The flexible, articulated arm of claim 21, wherein said superelastic material is a nickel-titanium alloy.

23. A flexible, articulated arm comprising:
a first link having a first contact surface, a second contact surface and a first cable opening passing therethrough,
a second link having a third contact surface, a fourth contact surface and a second cable opening passing therethrough,
a third link having a fifth contact surface, a sixth contact surface and a third cable opening passing therethrough,
wherein said second contact surface engages said third contact surface,
wherein said fourth contact surface engages said fifth contact surface,
a tension cable extending through said first, second and third cable openings,
and a security cable connected with said first, second and third links.

24. The flexible, articulated arm of claim 23, wherein each of said first, second and third links has a security cable opening, and wherein said security cable passes through said security cable openings in each link.

25. The flexible, articulated arm of claim 23, wherein said security cable extends through said first, second and third cable openings.

26. The flexible, articulated arm of claim 23, further comprising an outer sleeve, wherein said first, second and third links are located within said outer sleeve.

27. A connector for a flexible, articulated arm, which is mounted on the end of the flexible arm and connects a tool thereto, the connector comprising:
a generally cylindrical outer collar having a first opening extending therethrough,
a generally cylindrical inner collar having a second opening extending therethrough,
a spring biased detent forming a portion of a sidewall of said inner collar,
a rounded projection extending from a distal end of said spring biased detent,
wherein when said outer collar is located around said inner collar, said reduced diameter section is aligned with said spring-biased detent, thereby holding said rounded projection inward,
and wherein a shaft of the tool is locatable within the second opening and wherein, when said shaft is placed within said inner collar and said outer collar is placed around said inner collar, said rounded projection seats in a recessed ball groove located on the shaft, thereby locking the position of the shaft with respect to a distal end of the flexible arm.
